(19) United States
(12) Patent Application Publication
(10) Pub. No.: US 2015/0136091 A1
(43) Pub. Date: May 21, 2015

(54) JET PUMP OF FUEL PUMP MODULE FOR VEHICLE

(71) Applicant: Hyundai Motor Company, Seoul (KR)

(72) Inventors: Bu Yeol Ryu, Whasung-Si (KR); Pil Seon CHOI, Whasung-Si (KR); Seung Hwan PARK, Whasung-Si (KR)

(73) Assignee: Hyundai Motor Company, Seoul (KR)

(21) Appl. No.: 14/280,194

(22) Filed: May 16, 2014

(30) Foreign Application Priority Data
Nov. 20, 2013 (KR) 10-2013-0141177

(51) Int. Cl. F02M 37/02

(52) U.S. Cl. CPC F02M 37/025
USPC 123/495

(57) ABSTRACT

A pressure jet pump of a fuel pump module for a vehicle can prevent an engine from stopping and disordering due to unstable fuel supply, by keeping fuel supply stable in driving under bad conditions. The pump includes: a nozzle portion into which some of fuel pressurized by a fuel pump flows; a fuel intake portion integrally formed at the rear end of the nozzle portion and having a plurality of suction holes around the circumference; a mixing chamber that is integrally formed at the rear end of the fuel intake portion and in which fuels flowing inside through the nozzle portion and the fuel intake portion are mixed; and a diffuser that is integrally formed at the rear end of the mixing chamber and through which fuel sent from the mixing chamber is diffused.

### CROSS-REFERENCE TO RELATED APPLICATION

The present application claims priority of Korean Patent Application Number 10-2013-0141177 filed Nov. 20, 2013, the entire contents of which application is incorporated herein for all purposes by this reference.

### BACKGROUND OF INVENTION

1. Field of Invention

The present disclosure relates to a jet pump of a fuel pump module in a fuel tank of a vehicle, and more particularly to a pressure type jet pump with high efficiency for improving unstable fuel supply in driving under bad conditions.

2. Description of Related Art

Fuel supply systems sending fuel from the fuel tank to the engine of vehicles are composed of, for vehicles equipped with a common Gasoline Direct Injection (GDI) engine, a fuel pump module sending the fuel in the fuel tank to the front of a high-pressure pump at the engine, a high-pressure pump increasing the pressure of the fuel supplied through the fuel pump module, a fuel pressure rail keeping the fuel sent through the high-pressure pump at high pressure before the fuel is injected into the cylinders of the engine, and injectors finally injecting the fuel kept at high pressure by the fuel pressure rail into the cylinders of the engine, and a fuel pressure sensor and a fuel pump controller may be additionally provided to control the fuel pump.

The fuel pump module is, as shown in FIG. 1, usually composed of a fuel pump 1, a fuel filter 2, a pre-filter 3, a reservoir cup 4, a jet pump 5, an anti-syphon valve 6, and a pressure regulator 7 and the functions of the components are as follows.

Fuel pump—pressurizing fuel in the fuel tank and sending it to the engine;

Fuel filter—removing impurities in the fuel sent to the engine by the fuel pump;

Pre-filter—removing large impurities in the fuel flowing into the fuel pump;

Reservoir cup—keeping fuel for a predetermined time to improve stability of fuel supply when fuel is moved by the fuel pump;

Jet pump—converting pressure energy into kinetic energy by passing some of the fuel pressurized by the fuel pump through a small nozzle, and sending the fuel around into the reservoir cup by using the negative pressure generated in the conversion;

Anti-syphon valve—preventing the fuel in the reservoir cup from flowing out through the jet pump when the engine is in stop; and

Pressure regulator—maintaining the pressure of the fuel sent to the engine at a predetermined level.

The jet pump generally has a mixing chamber 20 and a diffuser 30 at rear end of the nozzle 10, as shown in FIG. 2, in order to efficiently generate pressure (negative pressure) that is generated when passing some of the pressurized fuel through a small nozzle.

In a common fuel tank, only one jet pump is mounted and makes the fuel therein flow into the reservoir cup.

Further, though not shown in the figure, for a saddle type fuel tank, two jet pumps are usually mounted and used as a negative pressure type dual jet pump, in which one of the jet pumps sends fuel in the main chamber of the tank (the space of the tank at the side where a fuel pump is disposed) into a reservoir cup and the other jet pump sends fuel in the sub-chamber (the space of the tank where a fuel pump is not disposed) to the main chamber.

The negative pressure dual jet pump used in a saddle type fuel tank has a defect of low efficiency due to a large distance between the fuel intake port and the portion where the negative pressure is generated and has a problem in that the intake pipe at the sub-chamber slowly recovers when it is exposed to the air and then sunk into the fuel again.

Further, the negative pressure dual jet pump has another problem in that the engine is frequently stopped and disordered by unstable fuel supply in driving under bad conditions such as high-speed turning, rapid acceleration, and rapid deceleration due to a decrease in efficiency of the jet pumps at the main chamber and the sub-chamber.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a pressure type jet pump of a fuel pump module for a vehicle which can prevent an engine from stopping and disordering due to unstable fuel supply, by keeping fuel supply stable in driving under bad conditions.

Various aspects of the present invention provide for a pressure type jet pump of a fuel pump module for a vehicle which includes: a nozzle portion into which some of fuel pressurized by a fuel pump flows; a fuel intake portion integrally formed at the rear end of the nozzle portion and having a plurality of suction holes around the circumference; a mixing chamber that is integrally formed at the rear end of the fuel intake portion and in which fuels flowing inside through the nozzle portion and the fuel intake portion are mixed; and a diffuser that is integrally formed at the rear end of the mixing chamber and through which fuel sent from the mixing chamber is diffused.

The suction holes may be sequentially formed around the fuel intake portion, for example, the fuel intake portion has a net structure with the suction holes sequentially formed vertically and horizontally along the circumferential surface.

Further, the front end of the nozzle portion may be sealed with a cap and a fuel discharge port for ejecting fuel is formed at the rear end.

The nozzle portion may have a valve mount protruding from a portion of the circumferential surface where the fuel intake port is formed, and a valve assembly for preventing backward flow of fuel is disposed in the valve mount.

The valve assembly may include: a valve housing having a fuel intake pipe formed at the top and assembled to the valve mount; a valve seat inserted in the valve housing and seated on the fuel intake port of the nozzle portion; and an anti-syphon valve elastically supported on the valve seat and opening/closing the fuel intake pipe.

The valve seat may have an outer diameter smaller than the inner diameter of the valve housing and the diameter of the fuel intake port and has a support end integrally formed to hold the valve seat over the fuel intake port.

Further, the valve assembly may include a return spring disposed between the valve seat and the anti-syphon valve to vertically elastically support the anti-syphon valve.

Further, the valve housing may have a pair of anti-separation arms formed on the outer circumferential surface and the valve mount has locking steps formed to lock and fix the anti-separation arms when the valve housing is assembled.

The pressure type jet pump of a fuel pump module for a vehicle according to various aspects of the present invention can stably supply fuel even in driving under bad conditions such as high-speed turning, rapid acceleration, and rapid deceleration, such that it is possible to prevent an engine from stopping and disordering due to unstable fuel supply in driving under bad conditions in the related art.

The present methods and apparatuses have other features and advantages apparent from the accompanying drawings, incorporated herein, and below Detailed Description, which together serve to explain certain principles of the present invention.

### BRIEF DESCRIPTION OF THE DRAWINGS

FIG. 1 is a view showing the configuration of a typical fuel pump module;

FIG. 2 is a view showing a jet pump for a fuel pump module of the related art;

FIGS. 3 and 4 are views showing the external structure of an exemplary pressure type jet pump according to the present invention;

FIG. 5 is a view showing the internal structure of an exemplary pressure type jet pump according to the present invention; and

FIG. 6 is a view showing the flow of fuel in an exemplary pressure type jet pump according to the present invention.

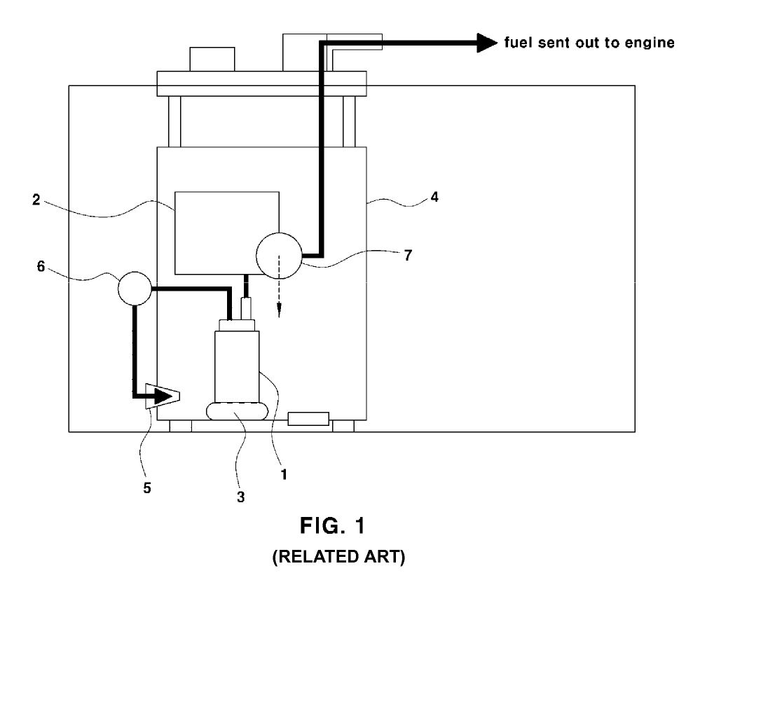

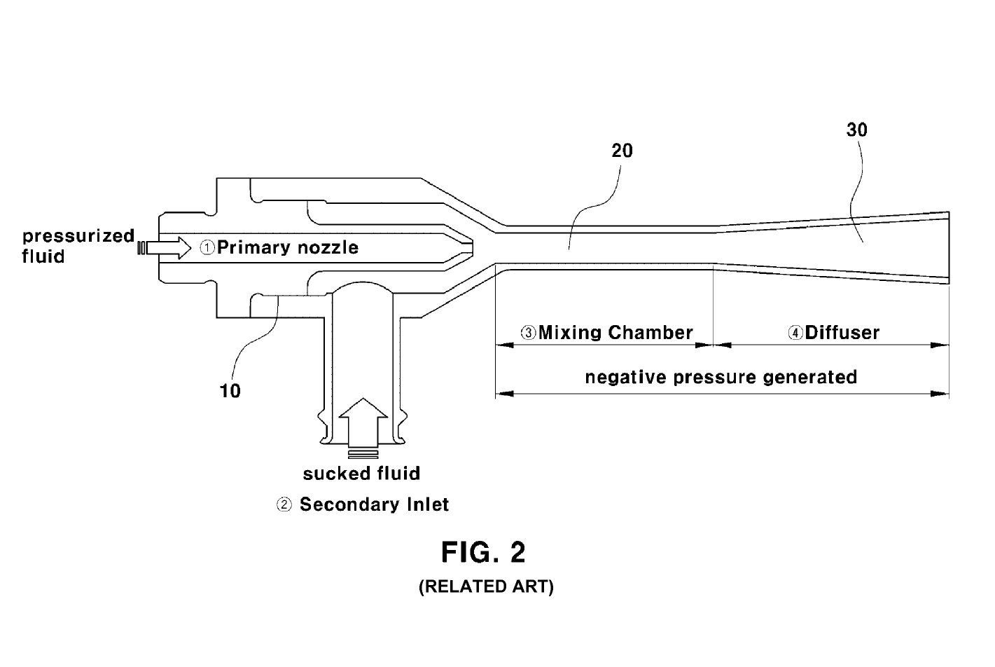

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to a pressure type jet pump of a fuel pump module mounted in a fuel tank of a vehicle, particularly a pressure type jet pump with high efficiency which can stably supply fuel even in driving under bad conditions.

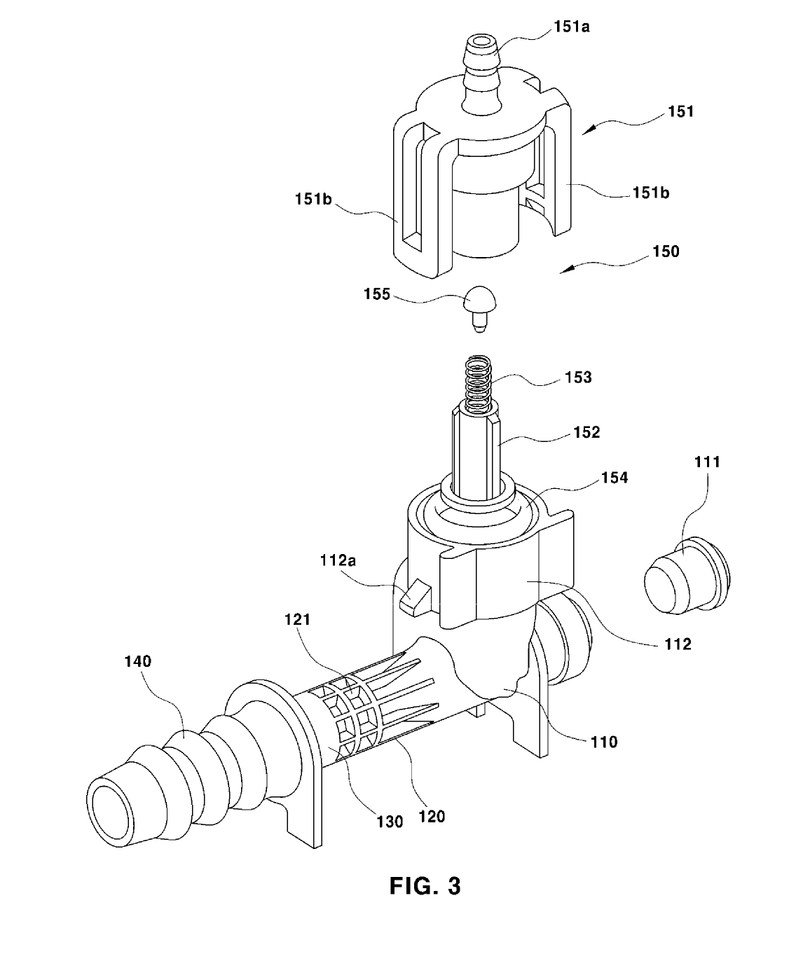

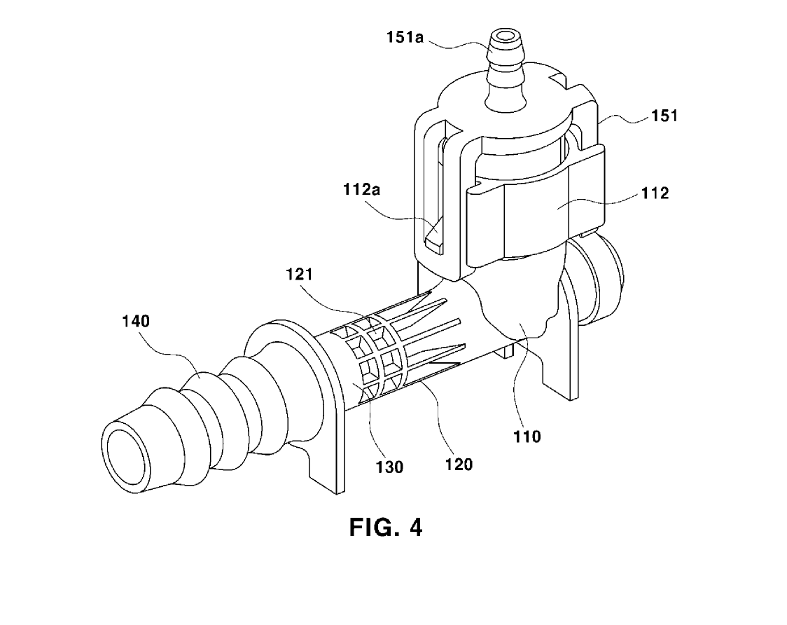

Referring to FIGS. 3 to 5, a pressure type jet pump according to various embodiments of the present invention includes a nozzle portion 110 into which some of fuel pressurized by a fuel pump flows, a fuel intake portion 120 extending integrally from the rear end of the nozzle portion 110, a mixing chamber 130, a diffuser 140, and a valve assembly 150 assembled to the top of the nozzle portion 110. One will appreciate that such integral components, as well as the integral components discussed below, may be monolithically formed with one another.

The pressure type jet pump is formed by connecting the fuel intake portion 120, the mixing chamber 120, and the diffuser 140 in a line from the nozzle portion 110.

The nozzle portion 110 is a hollow pipe with the front end sealed with a cap 111 and the rear end tapered.

A fuel discharge port 114 through which fuel (pressurized by a fuel pump) flowing inside through the fuel intake port 113 is ejected is formed at the rear end of the nozzle portion 110.

The cap 111 is fitted on the front end of the nozzle portion 110 and melted, such that it can seal the front end of the nozzle portion 110.

The nozzle portion 110 has a valve mount 112 vertically and integrally protruding from a portion of the circumferential surface and the fuel intake port 113 for inflow of fuel is formed at the portion of the circumferential surface of the nozzle portion 110 where the valve mount 112 is formed.

The fuel intake port 113 allows some of the fuel pressurized by the fuel pump to be supplied into the nozzle portion 110.

The valve assembly 150 is disposed in the valve mount 112 to prevent fuel from flowing backward through the fuel intake port 113. The valve assembly 150 will be described in detail below.

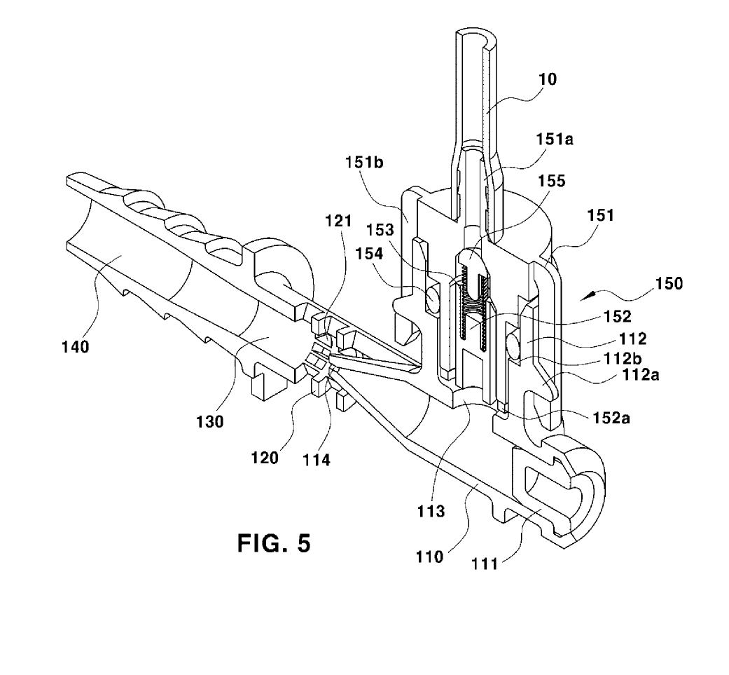

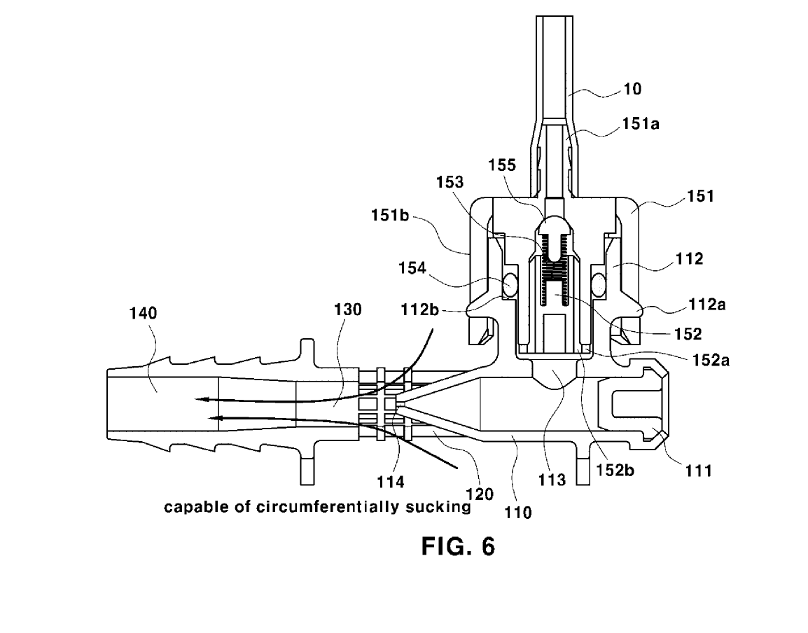

For reference, the reference numeral ‘10’ in FIGS. 5 and 6 indicates a fuel transporting pipe 10 connected to a fuel intake pipe 151 a of a valve housing 151 and the fuel transporting pipe 10, a pipe for transporting some of the fuel pressurized by the fuel pump, supplies fuel into the nozzle portion 110.

The fuel intake portion 120 integrally extending in a line from the rear end of the nozzle portion 110 and has a cylindrical shape with the tapered rear end and the fuel discharge portion 114 of the nozzle portion 110 therein, and a plurality of suction holes 121 is sequentially formed vertically and horizontally around the cylindrical shape in the shape of a net.

The suction holes 121 are sequentially formed around the fuel intake portion 120.

The suction holes 121 may be formed in rectangles, polygons, or circles through the fuel intake portion 120.

Since the fuel intake portion 120 is formed with the suction holes circumferentially connected, at the tapered rear end of the nozzle portion 110, the efficiency is maximized in comparison to the structure sucking fuel in only one direction and the fuel around is sucked through the all side along the circumferential surface, such that the flow of sucked fuel can be stabilized.

Since the fuel intake portion 120 having the net structure connects the nozzle portion 110, the mixing chamber 130, and the diffuser 140, it achieves the effect of preventing impurities from flowing into the sucked fuel, and accordingly, it can function as a mesh filter, such that when it is applied to a fuel pump module, the pre-filter at the intake side of the fuel pump module can be removed.

Further, since the mixing chamber 130 is provided as a hollow pipe and integrally formed at the rear end of the fuel intake portion 120, the fuels flowing inside from the nozzle portion 110 and the fuel intake portion 120 are mixed.

Referring to FIG. 6, the inner diameter of the mixing chamber 130 is maintained without a change from the front end to the rear end.

Since the diffuser 140 is provided as a hollow pipe and integrally formed at the rear end of the mixing chamber 130, the fuel transported from the mixing chamber 130 is diffused.

Referring to FIG. 6, the front end portion of the diffuser 140 gradually increases in inner diameter as it goes to the rear side and the inner diameter of the rear end portion is maintained without a change.

On the other hand, the valve assembly 150 includes the valve housing 151 coupled to the valve mount 112 of the nozzle portion 110, a valve seat 152 inserted in the valve housing and positioned over the fuel intake portion 113 of the nozzle portion 110, and an anti-syphon valve 155 elastically supported on the valve seat 152.

Referring to FIGS. 5 and 6, the valve assembly 150 is disposed on the valve mount 112, which is positioned over the fuel intake port 113 of the nozzle portion 110, in order to prevent fuel from flowing backward through the fuel intake portion 113.

The valve mount 112 is formed in a hollow cylinder with the top open and has locking steps 112a on the outer circumferential surface to prevent the valve housing 151 from separating and a stepped portion 112b around the inner circumferential surface to seat an O-ring 154.

The O-ring 154 is disposed between the stepped portion 112b of the valve mount 112 and the valve housing 151, and removes the gap between the valve mount 112 and the valve housing 151 and seals them.

The valve housing 151 can be brought in close contact, when vertically inserted in the valve mount 112 and has a pair of anti-separation arms 151b locked and fixed to the locking steps 112a of the valve mount 112.

The anti-separation arms 141b are disposed at the left and right sides of the valve housing 151 and have hole structures that are locked to the locking steps 112a when the valve housing 151 is inserted in the valve housing 112.

The valve seat 152, which is provided to hold the anti-syphon valve 155 at the lower end of the fuel intake pipe 151a of the valve housing 151, over the fuel intake port 113 of the nozzle portion 110, is disposed over the fuel intake port 113 of the nozzle portion 110 and supports the anti-syphon valve 155.

The valve seat 152 has an outer diameter smaller than the inner diameter of the valve housing 151 and the diameter of the fuel intake port 113 in order to maintain a predetermined gap with the inner circumferential surface of the valve housing 151 and be positioned over the fuel intake port 113 of the nozzle portion 110, and has a bridge 152b and a support end 152a integrally formed on the outer side.

The support end 152a, which is seated on the edge of the fuel intake port 113 of the nozzle portion 110 and supports the valve seat 152 over the fuel intake port 113, is formed in a ring, disposed at the lower end of the valve seat 153, and integrally connected to the outer circumferential surface of the valve seat 152 by the bridge 152b.

A plurality of bridges 152 is arranged with regular intervals between the valve seat 152 and the support end 152a, and they integrally connects the support end 152a and the valve seat 152 without cutting the flow of fuel between the valve seat 152 and the valve housing 151.

As shown in FIG. 6, the lower end of the valve housing 151 is disposed over the support end 152a.

The anti-syphon valve 155, which is provided to open/close the fuel intake pipe 151a of the valve housing 151, has a rounded top to increase close contact with the lower end of the fuel intake pipe 151a.

The anti-syphon valve 155 opens the fuel intake pipe 151a of the valve housing 151 while pushed by the pressure of fuel when the fuel flows inside, and closes the fuel intake pipe 151a by returning when fuel stops flowing inside, such that it prevents fuel from flowing backward through the fuel intake pipe 151a.

To this end, a return spring 153 for elastically supporting the anti-syphon 155 upward is disposed between the valve seat 152 and the anti-syphon valve 155.

The return spring 153 is compressed by the pressure of fuel and helps the anti-syphon valve 155 move down when the fuel flows inside, and it returns and moves upward the anti-syphon valve 155 back to the previous position when the fuel stops flowing inside, thereby elastically supporting the anti-syphon valve 155.

The operation state of the pressure type jet pump according to various embodiments of the present invention is described hereafter.

As fuel flows into the fuel intake pipe 151a of the valve housing 151, the anti-syphon valve 155 moves down and opens the pipe and the fuel flowing in between the valve seat 152 and the valve housing 151 flows into the nozzle portion 110 through the fuel intake port 113.

As the fuel flowing in the nozzle portion 110 is ejected through the fuel discharge port 114, negative pressure is formed behind the nozzle portion 110 (in the mixing chamber and the diffuser), such that the fuel around is sucked through the fuel intake portion 120 in all directions of the circumferential surface, as shown in FIG. 6.

The sucked fuel is mixed with the fuel ejected from the nozzle portion 110 in the mixing chamber 130 and moves while diffusing through the diffuser 140.

When fuel stops flowing into the fuel intake pipe 151a of the valve housing 151, the anti-syphon valve 155 is returned upward by the elastic restoring force of the return spring 153, such that the fuel intake pipe 151a is closed and fuel flowing into the nozzle portion 110 is stopped.

As the result of measuring the fuel intake amount (the amount of fuel flowing inside through the fuel intake portion), it was found that the fuel intake amount was increased in comparison to the related art and the driving efficiency was also improved in comparison to the related art, in the pressure type jet pump of the present invention.

Further, in the pressure type jet pump of the present invention, it was found that the kinetic energy of turbulence was decreased at the rear end of the nozzle portion in comparison to the related art and uniform negative pressure was generated in the mixing chamber, and it was found that fuel is sucked not in only one direction, but in all directions of the circumferential surface, such that the flow of sucked fuel was stabilized and there was no vortex at the fuel discharge port of the nozzle portion.

The pressure type jet pump of the present invention improves stability of fuel supply in a vehicle by increasing the efficiency, such that it is possible to keep fuel supply stable and prevent an engine from stopping and disordering, even in driving under bad conditions.

For convenience in explanation and accurate definition in the appended claims, the terms lower, rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A jet pump of a fuel pump module for a vehicle, comprising:
a nozzle portion into which fuel pressurized by a fuel pump flows;
a fuel intake portion integrally formed at a rear end of the nozzle portion and having a plurality of suction holes around the circumference;
a mixing chamber integrally formed at a rear end of the fuel intake portion and in which fuel flowing inside through the nozzle portion and the fuel intake portion are mixed; and
a diffuser integrally formed at a rear end of the mixing chamber and through which fuel sent from the mixing chamber is diffused.

2. The jet pump of claim 1, wherein the suction holes are sequentially formed around the fuel intake portion.

3. The jet pump of claim 1, wherein the fuel intake portion has a net structure with the suction holes sequentially formed vertically and horizontally along the circumferential surface.

4. The jet pump of claim 1, wherein in the nozzle portion, a front end is sealed with a cap and a fuel discharge port for ejecting fuel is formed at the rear end.

5. The jet pump of claim 1, wherein the nozzle portion has a valve mount protruding from a portion of the circumferential surface where the fuel intake port is formed, and a valve assembly for preventing backward flow of fuel is disposed in the valve mount.

6. The jet pump of claim 5, wherein the valve assembly includes:
a valve housing having a fuel intake pipe formed at the top and assembled to the valve mount;
a valve seat inserted in the valve housing and seated on the fuel intake port of the nozzle portion; and
an anti-syphon valve elastically supported on the valve seat and opening/closing the fuel intake pipe.

7. The jet pump of claim 6, wherein the valve seat has an outer diameter smaller than an inner diameter of the valve housing and a diameter of the fuel intake port, and has a support end integrally formed to hold the valve seat over the fuel intake port.

8. The jet pump of claim 6, wherein the valve assembly includes a return spring disposed between the valve seat and the anti-syphon valve to vertically elastically support the anti-syphon valve.

9. The jet pump of claim 6, wherein the valve housing has a pair of anti-separation arms formed on an outer circumferential surface and the valve mount has locking steps formed to lock and fix the anti-separation arms when the valve housing is assembled.

10. The jet pump of claim 6, wherein the valve assembly includes an O-ring disposed between the valve housing and the valve mount.
